(19) United States
(12) Patent Application Publication
(10) Pub. No.: US 2009/0006311 A1
(43) Pub. Date: Jan. 1, 2009

(54) AUTOMATED SYSTEM TO IMPROVE SEARCH ENGINE OPTIMIZATION ON WEB PAGES

(75) Inventors: Chyr-Chong (Joseph) Ting, San Jose, CA (US); Adam Hyder, Los Altos, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/770,083

(22) Filed: Jun. 28, 2007

(51) Int. Cl. G06F 17/30; G06F 7/10

(52) U.S. Cl. 707/2; 707/E17.009; 707/E17.01; 707/E17.017

(57) ABSTRACT

A system and method for automated search engine optimization (SEO) are disclosed. The automated SEO may analyze search query logs, or a search log database to determine popular concepts/units which may be automatically utilized to optimize a site or page for search engine results. The site or page is edited based on the automated SEO. In particular, the search log database may provide a unit frequency list reflecting the popularity of various units. The more popular units that are related to the content of the page may be used in the automated SEO of the page. The unit frequency list may be compared with the existing units of a page, so that the more popular concepts within the page may be emphasized.

### BACKGROUND

The Internet is a valuable resource for providing users with information. In particular, consumers use the Internet to find information and make decisions among online entities such as websites, online merchants, online companies, or online services. In addition, the Internet is evolving into a type of informational utility that helps consumers make important decisions in their offline lives as well by providing services that help them manage more of their day-to-day offline activities and needs.

However, the amount of information available online is so large that it may be difficult to find relevant information. Online searching is a common way for consumers to locate information, goods, or services on the Internet. A consumer may use an online search engine to type in one or more keywords (also referred to as a search term or search query) to search for pages or web sites with information related to the keyword(s). The search results that are shown on the search engine page include links to pages or sites with content that is related to the keyword(s).

Because search engines are responsible for directing a portion of web traffic to various pages, it is important for pages to appear within the search results for related search queries. The search results from a search engine are often ranked based on relevancy, and the pages listed first are generally deemed to be the most relevant. Accordingly, it is desirable for a web page operator to have his/her web page appear near the top of the list of search results. For example, a website selling sunglasses would like to appear near the top of the search results page for the search query “sunglasses.”

Search Engine Optimization (SEO) refers to actions by a web site to improve its presence and positioning for relevant search queries. The most popular search engines, including Yahoo!®, Google®, and Microsoft Live®, may utilize similar techniques for determining the relevancy of search results and SEO may include a site's attempts to more accurately appear in those search results. SEO may be performed by improving the labels, tags and information on a site. Accordingly, it is desirable to improve the SEO of pages, so that those pages appear in search results for relevant search queries related to the content of the pages.

### BRIEF DESCRIPTION OF THE DRAWINGS

The system and method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is an illustration of a network environment;

FIG. 2 is a flowchart depicting an embodiment for search engine optimization;

FIG. 3 is a diagram illustrating an embodiment of the search engine optimization of a page; and

FIG. 4 is an illustration of a general computer system for use with the disclosed embodiments.

### DETAILED DESCRIPTION

By way of introduction, the embodiments described below include a system and method for search engine optimization (SEO). The embodiments relate to SEO utilizing search query logs, which may be stored in a search log database to determine popular concepts or units which may then be utilized to optimize a site or page. A concept and unit may be a phrase or group of words that tend to appear together as will be described below. In particular, the search log database may provide a frequency list reflecting the popularity of various units. Popularity may be based upon the frequency with which a particular unit is searched for. In particular, the more searches that are performed for a particular unit, the more popular the unit is. The more popular units that are related to the content of the page may be injected into the page. The frequency list may be compared with the existing units of a page, so that the more popular units within the page may be emphasized.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

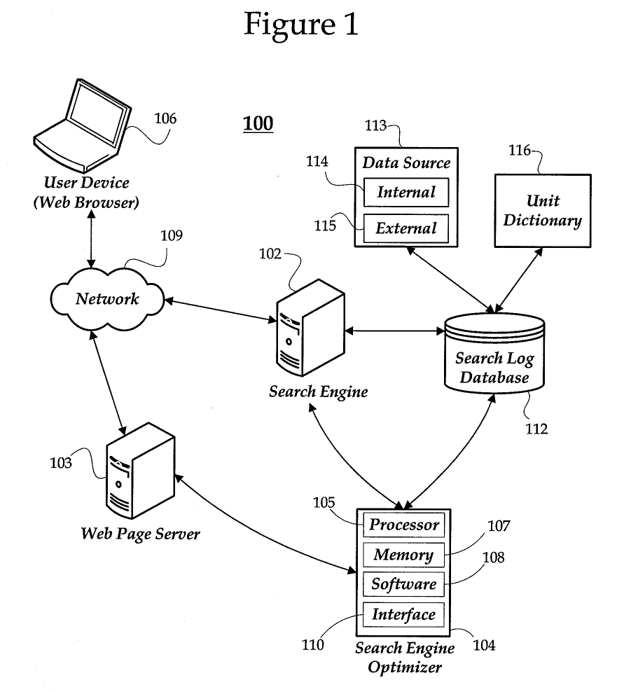

FIG. 1 is a block diagram illustrating an embodiment of an exemplary network system 100 for search engine optimization (SEO). In particular, system 100 includes a search engine optimizer 104 that may edit the structure and information of a page to improve its status and position in search results from search engines. A user device 106 is coupled with a search engine 102 through the network 109. The search engine 102 is coupled with a search log database 112, and both are coupled with the search engine optimizer 104. The search log database 112 is coupled with a data source 113 and a unit dictionary 116. A web page server 103 may be coupled with the user device 106 through the network 109, and/or coupled with the search engine optimizer 104. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

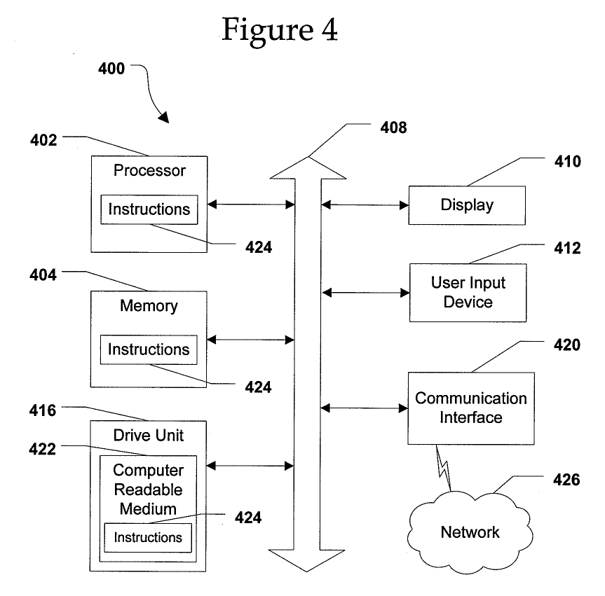

The user device 106 may be a computing device for a user to connect to a network 109, such as the Internet. Examples of a user device include but are not limited to a personal computer, personal digital assistant (“PDA”), cellular phone, or other electronic device. The user device 106 may be configured to access other data/information in addition to web pages over the network 109 with a web browser, such as INTERNET EXPLORER® (sold by Microsoft Corp., Redmond, Wash.). The user device 106 may enable a user to view pages over the network 109, such as the Internet. The user device 106 may be the user device described below with respect to FIG. 4.

The user device 106 may be configured to allow a user to interact with the web page server 103 or other components of the system 100. In one embodiment, the user device 106 may receive and display a site or page provided by the web page server 103, as well as receive and display a search engine page provided by the search engine 102. The user device 106 may include a keyboard, keypad or a cursor control device, such as a mouse, or a joystick, touch screen display, remote control or any other device operative to allow a user to interact with the page(s) provided by the web page server 103 and/or the search engine 102.

The web page server 103 provides a site or a page over a network, such as the network 109 or the Internet. A site or page may refer to a web page or a series of related web pages which may be received or viewed over a network. The site or page is not limited to a web page, and may include any information accessible over a network that may be displayed at the user device 106. In one embodiment, a site may refer to a series of pages which are linked by a site map. For example, the web site of www.yahoo.com (operated by Yahoo! Inc., in Sunnyvale, Calif.) may include thousands of pages, which are included at yahoo.com. Accordingly, the SEO described below may optimize an individual page, or may optimize a site including a plurality of pages. Hereinafter, a page will be described as a web page, a web site, or any other site/page accessible over a network. The web page server 103 may provide a single page, or may provide multiple pages. For example, the single page may include one web page, or the multiple pages may be a series of web pages or a site that is related under a common domain. A user of the user device 106 may access a page provided by the web page server 103 over the network 109. As described below, the page provided by the web page server 103 may be optimized using the search engine optimizer 104.

The search engine 102 is coupled with the user device 106 through the network 109, as well as being coupled with the search engine optimizer 104 and the search log database 112. In one embodiment, the search engine 102 includes an interface, such as a web page, e.g., the web page which may be accessed on the World Wide Web at yahoo.com, which is used to search for pages which are accessible via the network 109. The user device 106, autonomously or at the direction of the user, may input a search query (also referred to as a search term or a search keyword) for the search engine 102. A single search query may include multiple words or phrases. The search engine 102 may perform a search for the search query and display the results of the search on the user device 106. The results of a search may include a listing of related pages or sites. Generally, the listing of related pages is ordered by relevance with the most relevant pages appearing first. As described below, the search engine optimizer 104 is configured to improve a page's relevance or position in a search results list for a particular search query.

The search log database 112 includes records or logs of at least a subset of the search queries entered in the search engine 102 over a period of time and may also be referred to as a search query log, search term database, keyword database or query database. The search log database 112 may include search queries from any number of users over any period of time. Alternatively, the search log database 112 may include records or logs of a subset of the queries or requests for data entered at the search engine 102 over a period of time. The search log database 112 may also include Internet browsing data. In one embodiment, the search log database 112 includes all search queries that were made with the search engine 102. The records of search queries in the search log database 112 may be used to generate a frequency list of search queries which may be used to determine which queries are more popular than others.

The search log database 112 may also be coupled with a data source 113. The data source 113 may be an internal source of data 114, an external source of search data 115, or a combination of the two. An external data source 115 may include search results from other search engines or other sources. For example, a search engine other than search engine 102 may be an external data source 115 and provide search logs to the search log database 112. An internal data source 114 may include search data or other data from the search engine 102 itself. Other data may include other searching or web browsing tendencies identified by the search engine 102 that may reflect the popularity of a concept or query.

The search log database 112 may also be coupled with a unit dictionary 116. The unit dictionary 116 may be a database of search keywords that are coupled with one another as units. A unit may be one or more search keywords that are grouped together. Units may also be referred to as concepts or topics and are sequences of one or more words that appear in search queries. For example, the search query “New York City law enforcement” may include two units, e.g. “New York City” may be one unit and “law enforcement” may be another unit. A unit is a phrase of common words that identify a single concept. As another example, the search query “Chicago art museums” may include two units, e.g. “Chicago” and “art museums.” The “Chicago” unit is a single word, and “art museums” is a two-word unit. Units identify common groups of keywords to maximize the efficiency and relevance of search results. The categorization of search keywords into units is discussed in U.S. Pat. No. 7,051,023 issued May 23, 2006, entitled “SYSTEMS AND METHODS FOR GENERATING CONCEPT UNITS FROM SEARCH QUERIES,” which is hereby incorporated by reference. In addition, U.S. Publication No. 2005/0080795 (application Ser. No. 10/797,614), entitled “SYSTEMS AND METHODS FOR SEARCH PROCESSING USING SUPERUNITS,” U.S. Publication No. 2006/0122979 (application Ser. No. 11/006,466), entitled “SEARCH PROCESSING WITH AUTOMATIC CATEGORIZATION OF QUERIES,” U.S. Publication No. 2006/012294 (application Ser. No. 11/006,463), entitled “AUTOMATIC GENERATION OF TAXONOMIES FOR CATEGORIZING QUERIES AND SEARCH QUERY PROCESSING USING TAXONOMIES,” and U.S. Publication No. 2006/0167896 (application Ser. No. 11/295,166), entitled “SYSTEMS AND METHODS FOR MANAGING AND USING MULTIPLE CONCEPT NETWORKS FOR ASSISTED SEARCH PROCESSING,” all of which are hereby incorporated by reference, also relate to the categorization of search keywords, such as by units.

The unit dictionary 116 and the categorization of search queries into units may be used to analyze the search log database 112 to determine trends in searching. Trends in searching may be used to identify those searches or topics that may become popular based on the analysis of search logs over time. The popularity may be correlated with the relevance of a search and/or topic, such that the least popular topics may be deemed to be the least relevant. In one embodiment, a unit frequency list may be compiled based on the search queries stored in the search log database 112. The unit frequency list may identify the number of search queries for units over a period of time. For example, the unit frequency list may include data that the unit “New York City” was present in 100,000 search queries last week and the unit “law enforcement” was present in 1,000 search queries last week. Accordingly, the relative popularity of units may be determined based on the search query frequency, with the more popular units being searched for more frequently.

In one embodiment, the web page server 103, the search engine 102 and/or the search log database 112 may be coupled with the search engine optimizer 104. The search engine optimizer 104 utilizes the search log database 112 to identify the relative popularity of units. In particular, the search engine optimizer 104 determines the frequency with which a unit is searched for. A unit frequency list may identify the frequencies that a list of units are searched for. Accordingly, a review of the search log database 112 may be used to identify trends in those units that have increased in popularity over time or are currently increasing in popularity so that a page may be optimized based on the trends.

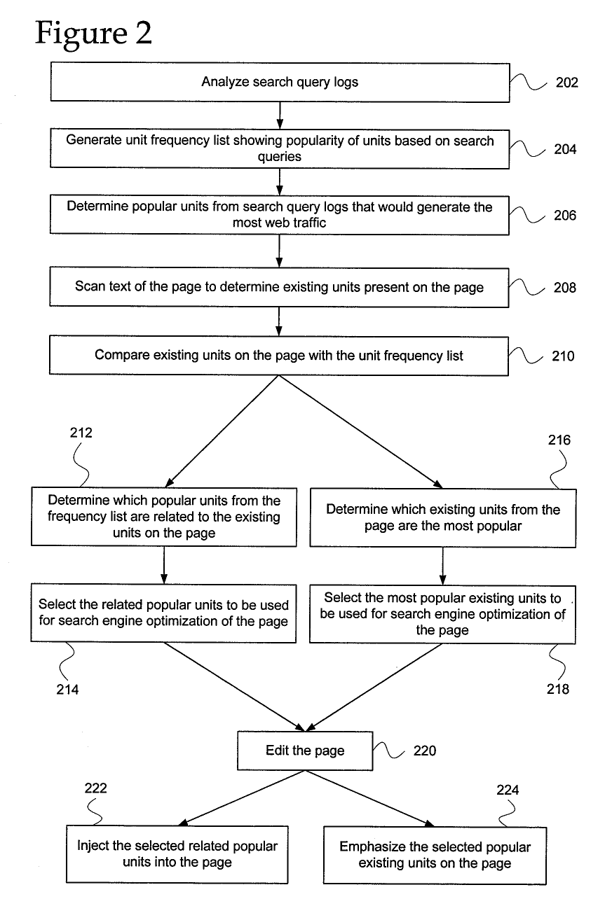

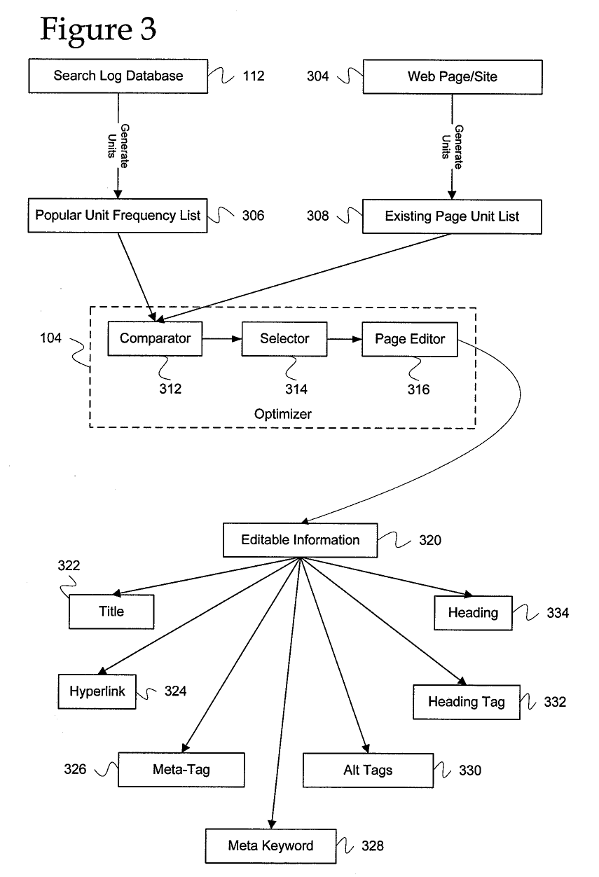

Based on the relative popularity of particular units (as determined by the frequency with which the particular unit is searched for) the search engine optimizer 104 may make changes to a page to optimize its presence and position in search results for popular searches. FIGS. 2 and 3 describe an embodiment by which the search engine optimizer 104 utilizes the popularity of units to optimize a page. FIG. 3 also illustrates examples of editable information on a page that may be modified to optimize that page.

The search engine optimizer 104 may be a computing device as described below with respect FIG. 4. In one embodiment, the search engine optimizer 104 includes a processor 105, memory 107, software 108 and an interface 110. The search engine optimizer 104 may be a separate component from the search engine 102 and the web page server 103. In an alternative embodiment, any of the search engine optimizer 104, search engine 102, and the web page server 103 may be combined as a single component. The interface 110 may communicate with any of the search engine 102, search log database 112, and web page server 103. In one embodiment, the search engine optimizer 104 automatically optimizes a page without interaction from a user. Alternatively, the interface 110 may include a user interface configured to allow a user to interact with any of the components of the search engine optimizer 104.

The processor 105 in the search engine optimizer 104 may include a central processing unit (CPU), a graphics processing unit (GPU), a digital signal processor (DSP) or other type of processing device. The processor 105 may be a component in any one of a variety of systems. For example, the processor 105 may be part of a standard personal computer or a workstation. The processor 105 may be one or more general processors, digital signal processors, application specific integrated circuits, field programmable gate arrays, servers, networks, digital circuits, analog circuits, combinations thereof, or other now known or later developed devices for analyzing and processing data. The processor 105 may operate in conjunction with a software program, such as code generated manually (i.e., programmed).

The processor 105 may be coupled with a memory 107, or the memory 107 may be a separate component. The interface 110 and/or the software 108 may be stored in the memory 107. The memory 107 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. In one embodiment, the memory 107 includes a random access memory for the processor 105. In alternative embodiments, the memory 107 is separate from the processor 105, such as a cache memory of a processor, the system memory, or other memory. The memory 107 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 107 is operable to store instructions executable by the processor 105.

The functions, acts or tasks illustrated in the figures or described herein may be performed by the programmed processor executing the instructions stored in the memory 107. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 105 is configured to execute the software 108. The software 108 may include instructions for search engine optimization.

The interface 110 may be a user input device or a display. The interface 110 may include a keyboard, keypad or a cursor control device, such as a mouse, or a joystick, touch screen display, remote control or any other device operative to interact with the search engine optimizer 104. The interface 110 may include a display coupled with the processor 105 and configured to display an output from the processor 105. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 105, or as an interface with the software 108 for providing input parameters. In particular, the interface 110 may allow a user to interact with the search engine optimizer 104 to establish which page and which features of the page may be edited, as well as selecting which popular units may be injected into the page. Alternatively, the search engine optimizer 104 may update the page to optimize it for a search engine by automatically injecting or emphasizing popular units in that page.

Any of the components in system 100 may be coupled with one another through a network. For example, the search engine optimizer 104 may be coupled with the search engine 102, search log database 112, or web page server 103 via a network. Any of the components in system 100 may include communication ports configured to connect with a network. The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the web page server 103 or the search engine 102 may provide pages to the user device 106 over a network, such as the network 109. The network or networks described above, including the network 109, may be the network discussed below with respect to FIG. 4.

The web page server 103, the search engine 102, the search log database 112, the search engine optimizer 104, the unit dictionary 116 and/or the user device 106 may represent computing devices of various kinds, such as the components described with respect to FIG. 4. Such computing devices may generally include any device that is configured to perform computation and that is capable of sending and receiving data communications by way of one or more wired and/or wireless communication interfaces. Such devices may be configured to communicate in accordance with any of a variety of network protocols, as discussed above. For example, the user device 106 may be configured to execute a browser application that employs HTTP to request information, such as a web page, from the web page server 103, or a search page from the search engine 102. The present disclosure contemplates a computer-readable medium that includes instructions or receives and executes instructions responsive to a propagated signal, so that any device connected to a network can communicate voice, video, audio, images or any other data over a network.

FIGS. 2 and 3 illustrate the search engine optimization of a page. FIG. 2 is a flow chart illustrating an embodiment for search engine optimization. In particular, FIG. 2 illustrates search engine optimization (SEO) which may be performed by the search engine optimizer 104. FIG. 3 is a diagram illustrating an embodiment of the search engine optimization (SEO) of a page. In particular, FIG. 3 illustrates the search engine optimizer with its inputs and outputs.

In block 202, an analysis is performed on search query logs, such as the search log database 112. In particular, the search log database 112 is reviewed to determine the frequency with which each unit is searched for over a period of time. The search log database 112 is analyzed to generate units and create a unit frequency list 306 as in block 204. The unit frequency list 306 includes the search frequency for each unit that is searched. Alternatively, the unit frequency list 306 may be limited to a subset of the search queries, or may be limited to extracting units which are relevant to the optimized page. For example, if a particular page includes content about sunglasses, then the unit frequency list 306 that is mined from the search log database 112 may include the search frequencies for any units that are related to sunglasses.

The search frequency may be a reflection of the popularity of particular units. In block 206, the unit frequency list may be used to determine which units may generate the most traffic to a website. The time period over which the frequency of a unit is measured may be varied for the unit frequency list to determine which units are consistently popular, and which units are currently popular, such as those that recently experienced a spike in popularity. A longer time period may be used to establish consistently popular units, such as over one year or over five years. Alternatively, a relatively short time period such as a week, a day, or an hour may establish which units are currently popular. A shorter time period may reflect current trends in the popularity of a unit. If the search engine optimizer 104 is repeatedly updating a page, then the short time period for popularity may be more effective to match the trends in popularity. Conversely, when the search engine optimizer 104 updates a page infrequently, such as once a week or once a month, then a longer time period for popularity may be more effective in determining those units that are consistently popular.

As discussed above, the search engine optimizer 104 is configured to analyze a page 304 (which may be provided by the web page server 103) and improve its status in search result lists from search engines, such as the search engine 102. Alternatively, as described above, the search engine optimizer 104 may optimize a site, which may be a plurality of related pages. The page that is analyzed may be a web page, such as an HTML document. For simplicity, the description below will describe the optimization of a page, and that page will be described as being a web page throughout the description of FIGS. 2 and 3. In block 208, the page 304 is analyzed to generate units and create an existing page unit list 308 that includes a list of which units are currently present in the content, information, tags, and metadata of the page 304. In particular, the existing page unit list 308 may include the existing units that are present in the editable information 320 of the page 304 as discussed below.

The search engine optimizer 104 may include a comparator 312 coupled with a selector 314, which is coupled with a page editor 316. The comparator 312 is configured to perform comparisons of the existing page unit list 308 with the unit frequency list 306 from the search log database 112 as in block 210. The comparator 312 may perform at least two types of comparisons. The first comparison includes determining which popular units from the unit frequency list 306 may be relevant or related to the page 304 as in block 212. The second comparison includes determining the popularity of the existing units from the existing page unit list 308 based on the unit frequency list 306 as in block 216. In particular, the second comparison includes determining the frequency with which the existing units of the existing page unit list 308 were searched for based on the unit frequency list 306. The frequency may be a reflection of the popularity of a unit and provides a measure for the relative popularity of each of the existing units from the existing page unit list 308.

The comparator 312 is coupled with the selector 314. The selector 314 is configured to analyze the comparisons performed by the comparator 312 at block 210 to determine which units may be most relevant for the SEO of the page. The selector 314 receives both comparisons from the comparator 312 and selects more popular units for each. For the first comparison in block 212, the selector 314 selects the more popular units from the unit frequency list 306 that are related to or relevant to the page as in block 214. Whether a unit is related to or relevant to a page may be based on a comparison of the existing units of that page with the popular units from the unit frequency list 306. For example, units that appear together in search queries may be related to one another. The relationship between units may be illustrated in the U.S. patent application “SEARCH PROCESSING WITH AUTOMATIC CATEGORIZATION OF QUERIES,” U.S. Publication No. 2006/0122979, U.S. Ser. No. 11/006,466, filed Dec. 6, 2004, the entire disclosure of which is incorporated by reference herein. For the second comparison in block 216, the selector 314 selects the more popular existing units from the existing page unit list 308 as in block 218. The selected units may then be used for the SEO of the page as discussed below.

The selected units may be passed from the selector 314 to the page editor 316. The page editor 316 is configured to edit the page to optimize it for search engine results. The SEO of the page may include editing at least some of the content, features, information, or tags of the page as in block 220. In particular, the optimization may be based on injecting popular related units into the page or emphasizing existing popular units. The page editor 316 may edit the page such that the selected popular units from the selector 314 in block 214 may be injected into the page as in block 222, and the more popular existing units from the selector 314 in block 218 may be emphasized on the page as in block 224.

The page editor 316 may edit the editable information 320 as shown in FIG. 3. The more popular units may be included in the editable information 320, and the existing more popular units may be emphasized in the editable information 320 by being included in the more relevant editable information 320. The editable information 320 may further include any information or features of the page 304 that the search engine 102 may utilize in generating a search result list of relevant pages. In other words, the SEO of the page 304 includes editing the relevant aspects of the page 304 that may be considered by the search engine 102. The examples of editable information 320 shown in FIG. 3 are exemplary of page features and information that may influence search results from the search engine 102.

The title 322 of the page 304 is an example of a feature that may be used for SEO. Each page includes a title 322 describing the contents of the page. The title 322 may be the title of the page that is viewable in the title bar of a web browser. The search engine 102 may use the title 322 to determine the content of a page. In one example, if you have a blog related to Chicago sports teams, then a title may be generic, such as “Chicago sports blog.” However, after comparing the unit frequency list 306 and the existing page unit list 308, it may be determined that Chicago Cubs® are currently very popular. Accordingly, the search engine optimizer 104 may select that unit and edit the title 322 to be “Chicago Cubs blog.” The popularity of the unit Chicago Cubs® may provide better search results than when the title 322 was “Chicago sports blog.”

The hyperlink 324 of the page 304 is an example of a feature that may be used for SEO. The hyperlink 324 includes the web address or domain of the page. In some cases the hyperlink 324 may be static and may not be easily changed. In one embodiment, a second hyperlink may be created that directs a user to the page associated with the original hyperlink 324. In the example discussed above, if the hyperlink for the Chicago sports blog page can be changed to reference the page as a Chicago Cubs® blog that may optimize the page in search results.

The meta-tag 326 of the page 304 is an example of a feature that may be used for SEO. The meta-tag 326 may be a description of the page 304. The description meta-tag 326 generally describes the page and may be used by search engines in ranking search results. In one embodiment, the meta-tag 326 is located in the head section of an HTML document and includes description of the page 304 from the creator of that page 304.

The search engine optimizer 104 may edit the meta-tag 326 description to include or emphasize those units that are more popular as determined in the unit frequency list 306 and the existing page unit list 308. In particular, units from the unit frequency list 306 may be injected into the meta-tag 326 when they are relevant or related to the page 304. Likewise, units from the existing page unit list 308 that are more popular may be emphasized within the meta-tag 326. For example, for a blog related to popular music, the meta-tag 326 may include a description about reviews of popular music. However, in the unit frequency list 306, if an artist, such as Britney Spears is popular, that artist may be injected into the meta-tag 326. The meta-tag 326 may be edited to describe the page 304 as including “music reviews of popular music, including Britney Spears.” If the meta-tag 326 already included a description mentioning the unit Britney Spears, then it may be edited to include multiple references to that unit, or may be edited to emphasize the unit at the beginning of the meta-tag 326.

The meta keyword 328 of the page 304 is an example of a feature that may be used for SEO. The meta keyword 328 includes a list of units that are identified by the page 304 as keywords describing the page 304. Similar to the meta-tag 326, the meta keyword 328 may be edited by the search engine optimizer 104 to emphasize or include more popular units.

The alt tags 330 of the page 304 are an example of a feature that may be used for SEO. The alt tags 330 are a text description of certain elements. The elements may include multimedia, such as images. The alt tag 330 may replace the element when that element cannot be shown or downloaded. For a user with limited bandwidth or with a mobile device, images may be replaced with their respective alt tags 330. Alternatively, when a user moves the mouse pointer over an image, the alt tag 330 may be shown as a description of the image.

The alt tags 330 may be used by search engines to classify and rank pages within search results. In particular, the search engine 102 may use the alt tags 330 to determine what the elements in a page are related to. Accordingly, the search engine optimizer 104 may edit the alt tags to further include or emphasize the more popular units. For example, a page 304 that is about guitars may include a picture of a certain guitar being played by John Mayer. Assuming that John Mayer is determined to be a popular unit, then the page 304 may be edited from describing the type of the guitar to injecting the unit “John Mayer” into the alt tag 330. For example, if the alt tag 304 described the “electric guitar,” then it may be edited to describe “John Mayer playing an electric guitar.” The editing of the alt tag 330 still is relevant to the page 304 and to the element that it describes, but it emphasizes or includes popular units that are related to the element.

The heading tag 332 of the page 304 is an example of a feature that may be used for SEO. The heading tag 332 is information about the page 304 that that relates to the header information of the page 304. The page 304 includes at least one heading tag 332 that further describes information and/or content from the page 304. In one embodiment, the heading tag 332 is a description of the heading of the page 304. The heading 334 of the page 304 is an example of a feature that may be used for SEO. The heading 334 is information stored in the header of the page 304. As with the other editable information 320, the heading tag 332 and the heading 334 may be edited by the search engine optimizer 104 to include or emphasize those units that are more popular as determined from the unit frequency list 306.

In one embodiment each of the editable information 320 may be ranked or given a point value that is reflective of its significance for SEO. For example, the point value may be from 0 (least relevant) to 100 (most relevant). The title 322 may have a value of 100 because it is important for search engines and for SEO, while the meta keyword 328 may have a value of 10 because it may be less important to search engines. The point value may be used to match the more popular units with the editable information 320 that has a higher point value. A particular unit may be limited to appearing in a certain number of the editable information 320 locations. For example, a given unit may be limited to appearing in only two spots, such as the title 322 and the heading 334. A dynamic programming algorithm may be used to edit the page to include units from the unit frequency list 306 in the editable information 320. In one embodiment, the most popular unit may be assigned to the two instances of editable information 320 with the highest value, while the second most popular unit is assigned to the two instances of editable information 320 with the next two highest values.

Referring to FIG. 4, an illustrative embodiment of a general computer system 400. The computer system 400 can include a set of instructions that can be executed to cause the computer system 400 to perform any one or more of the methods or computer based functions disclosed herein. Any of the components illustrated in the exemplary network system 100 in FIG. 1 may include the computer system 400 or any of the components in computer system 400. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication port 418. The communication port 418 may be a part of the processor 402 or may be a separate component. The communication port 418 may be created in software or may be a physical connection in hardware. The communication port 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for search engine optimization of a page comprising:
determining a plurality of popular units from a search query log, wherein the plurality of popular units from the search query log are based on a search frequency;
determining existing units present on the page;
selecting related popular units from the plurality of popular units from the search query log, wherein the related popular units are similar to the existing units of the page; and
editing the page to incorporate the selected related popular units into the page.

2. The method according to claim 1 wherein the incorporation of the selected related popular units into the page comprises incorporating at least a portion of the selected related popular units into at least one of a title, a hyperlink, a meta-tag, a meta keyword, a heading, a heading tag, or an alt tag for the page.

3. The method according to claim 1 wherein the act of determining a plurality of popular units from a search query log comprises generating a unit frequency list, wherein the unit frequency list includes the search frequency for the units.

4. The method according to claim 3 wherein the units from the search query log comprise phrases from search queries stored in the search query log.

5. The method according to claim 3 wherein the act of determining existing units present on the page comprises generating an existing page unit list comprising a listing of the existing units present on the page.

6. The method according to claim 5 wherein the act of selecting the related popular units from the plurality of popular units comprises comparing the existing page unit list with the unit frequency list to identify the related popular units from the unit frequency list that are related to the existing units from the existing page unit list.

7. The method according to claim 1 wherein the related popular units are similar to the existing units of the page when the related popular units and the existing units are included in at least one search query from the search query log.

8. A method for optimizing a page in search engine results, the method comprising:
generating a unit frequency list from a search log database, wherein the unit frequency list includes a search frequency for each unit in the unit frequency list, further wherein the search frequency for each unit establishes the unit's popularity;
generating an existing page unit list from the page, wherein the existing page unit list includes existing units that are present on the page;
comparing the existing page unit list with the unit frequency list;
selecting popular units from the existing page unit list based on the comparison, wherein the popular units from the existing page unit list are those units with a relatively higher search frequency in the unit frequency list; and
editing the page to emphasize the selected popular units;

9. The method according to claim 8 wherein the page comprises a web page.

10. The method according to claim 9 wherein the emphasis of the selected popular comprises incorporating the selected popular units into at least one of a title, a hyperlink, a meta-tag, a meta keyword, a heading, a heading tag, or an alt tag on the page.

11. The method according to claim 8 further comprising:
selecting units from the unit frequency list that are related to the existing page unit list; and
editing the page to incorporate the selected units from the unit frequency list.

12. The method according to claim 11 wherein the including of the selected units from the unit frequency list comprises incorporating at least a portion of the selected units into at least one of a title, a hyperlink, a meta-tag, a meta keyword, a heading, a heading tag, or an alt tag for the page.

13. In a computer readable storage medium having stored therein data representing instructions executable by a programmed processor for search engine optimization of a page, the storage medium comprising instructions operative for:
compiling a list of units present on the page;
receiving a unit frequency list from at least one search log database that includes a search frequency for a plurality of units;
comparing the list of units present on the page and the unit frequency list to determine a frequency of searches for the units on the list of units present on the page, wherein a higher search frequency represents higher popularity;
identifying popular units from the list of units present on the page based on the comparison with the unit frequency list, wherein the popular units from the list of units present on the page have a higher search frequency from the unit frequency list than other units from the list of units present on the page; and
modifying the page to emphasize the popular units within the page.

14. The storage medium according to claim 13 wherein the page comprises a web page.

15. The storage medium according to claim 14 wherein the emphasis of the popular units within the page comprises including at least a portion of the popular units within the editable information of the page.

16. The storage medium according to claim 15 wherein the editable information comprises at least one of a title, a hyperlink, a meta-tag, a meta keyword, a heading, a heading tag, or an alt tag on the page.

17. The storage medium according to claim 15 wherein the editable information is ranked based on relevance for search engines.

18. The storage medium according to claim 17 wherein the more popular units are included with the editable information that is ranked higher.

19. A system for search engine optimization (SEO) of a page comprising:
a web page server configured to provide the page;
a search engine coupled with the web page server and configured to provide search results based on a search query;
a search log database coupled with the search engine and configured to store a record of the search queries from the search engine; and
a search engine optimizer coupled with the web page server and the search log database, the search engine optimizer configured to receive the record of the search queries from the search engine to determine a popularity of the search queries, wherein the search engine optimizer is configured to edit the page to include the more popular search queries.

20. The system according to claim 19 wherein the search engine optimizer comprises:
a comparator configured to determine the popularity of the search queries based on the search log database, wherein the popularity of the search queries is based on frequency of searching from the search log database;
a selector coupled with the comparator and configured to select the more popular search queries, wherein the more popular search queries have a higher search frequency in the search log database; and
an editor coupled with the selector and configured to edit the page to include the more popular search queries.

21. The system according to claim 19 further comprising a user device coupled with the web page server and configured to access the page.

22. The system according to claim 21 wherein the page is provided to the user device from the web page server.

23. The system according to claim 21 wherein the search results are provided to the user device from the search engine in response to receiving a search query from the user device.
